(19) United States
(12) Patent Application Publication
(10) Pub. No.: US 2016/0092313 A1
(43) Pub. Date: Mar. 31, 2016

(54) Application Copy Counting Using Snapshot Backups For Licensing

(71) Applicant: Empire Technology Development LLC, Wilmington, DE (US)

(72) Inventor: Ezekiel Kruglick, Poway, CA (US)

(21) Appl. No.: 14/496,092

(22) Filed: Sep. 25, 2014

(51) Int. Cl. G06F 11/14; G06F 21/10

(52) U.S. Cl. CPC G06F 11/1458; G06F 21/105; G06F 2221/0768; G06F 2201/80

(57) ABSTRACT

Technologies are described herein to use snapshot backups for licensing. Some example technologies may access a snapshot backup that is taken during an execution of a virtual machine on a server. One or more snapshot backups may be examined to detect applications that executed on the server at a time the snapshot backup was taken. A determination may be made as to what applications that were identified are subject to a license. Licensing information may be provided that includes information associated with the one or more of the applications that are subject to the license.

### BACKGROUND

Unless otherwise indicated herein, the materials described in this section are not prior art to the claims in this application and are not admitted to be prior art by inclusion in this section.

Software providers may license software to customers. The license may grant a customer various rights to use the software. For example, the license may allow the customer to install and/or execute the software on a limited number of computers. In some cases, the company providing the software may rely on the customer to follow the terms of the license. For example, the company may rely on the customer to install the software on only the number of machines as specified by the license.

In other cases, licensing servers may be used to enforce the terms of the license. For example, a licensing server may be used to determine whether a software product is properly licensed as well as whether the software is executing according to the terms of the license. The use of licensing servers may be an added load on computing resources and management that may require the investment in the running, maintenance, and troubleshooting of licensing servers.

### SUMMARY

The present disclosure generally describes techniques to use snapshot backups to determine or identify applications that are subject to a license. Some example methods may include accessing a snapshot backup that is taken during the execution of a server. The snapshot backup may be examined to detect applications that executed on the server at the time the snapshot backup was taken. A determination may be made as to the applications that are subject to a license. Licensing information may be provided that includes information associated with the applications that are subject to the license.

In another example, an apparatus is described. The apparatus may include a processor and a network interface coupled to at least one server. The server may be configured to execute virtual machines (“VMs”). The processor may be configured to access snapshot backups that are taken during the execution of one or more virtual machines on the servers, examine the snapshot backups to detect applications that executed on the server that are subject to one or more licenses. The processor may also be used to store licensing information about the applications that are subject to the one or more licenses.

In a further example, a method is described. The method may include receiving a request for a physically unclonable function (“PUF”) response from a virtual machine (“VM”) on a first computing device. A simulated PUF response may be generated for the VM. A value of the simulated PUF response may remain consistent for the VM regardless of a physical computing device executing the VM. The simulated PUF response may be provided to the VM.

The foregoing Summary is illustrative only and is not intended to be in any way limiting. In addition to the illustrative aspects, embodiments, and features described above, further aspects, embodiments, and features will become apparent by reference to the Figures and the following Detailed Description.

### DESCRIPTION OF THE FIGURES

The foregoing and other features of this disclosure will become more fully apparent from the following Detailed Description, accompanying Figures, and appended claims. Understanding that these Figures depict only several embodiments in accordance with the disclosure and are, therefore, not to be considered limiting of its scope, the disclosure will be described with additional specificity and detail with reference to the accompanying Figures, in which:

FIG. 1 is a functional block diagram illustrating an example licensing system configured to utilize snapshot backups;

FIG. 2 is a functional block diagram illustrating a snapshot analyzer configured to analyze assembled snapshot backups for application(s) executing on one or more computing devices at different points in time;

FIG. 3 is a functional block diagram illustrating a PUF system configured to generate and deliver simulated PUFs;

FIG. 4 is a flow diagram illustrating an example process adapted to use snapshot backups for licensing;

FIG. 5 is a flow diagram illustrating an example process adapted to use PUFs with virtual machines; and

FIG. 6 is a block diagram illustrating an example computing device that is arranged to implement technologies relating to licensing of software using snapshot backups, all arranged in accordance with at least some embodiments presented herein.

### DETAILED DESCRIPTION

In the present Detailed Description, reference is made to the accompanying Figures, which form a part hereof. In the Figures, similar symbols typically identify similar components, unless context dictates otherwise. The illustrative embodiments described in the Detailed Description and Figures are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to technologies adapted to use snapshot backups to determine applications that are subject to a license. Snapshot backups may refer to a state of a computing device that is recorded at a particular point in time. In contrast to a full backup of a computing device, a snapshot backup might be obtained almost instantaneously without consuming resources of the computing device or affecting the operation of the application. For example, an application may continue to read and write during a time the snapshot backup is taken. Snapshot backups may be taken at different points in time (e.g., every few minutes) and may be combined using a snapshot assembler to generate an assembled snapshot backup.

In some examples, a snapshot analyzer may analyze one or more of the snapshot backups (e.g., the assembled snapshot backup) to determine the applications that are running at the time the snapshot backup(s) are taken. Different identification mechanisms may be used to identify the applications from the snapshot backups. For example, a fingerprint mechanism might be used to detect the applications that are executing at a particular point in time. As discussed in more detail below, all or a portion of the applications that might be executing on a computing device may be fingerprinted. The fingerprint for an application may uniquely identify the application. The snapshot analyzer may use these fingerprints to identify the applications that are executing at the time the snapshot backups are taken. In some examples, the applications may be executing in one or more virtual machines that are executing on computing devices (e.g., servers) that are part of a data center.

A licensing server, or some other computing device, may determine what applications identified by the snapshot analyzer are subject to a license. For example, the licensing server might check licensing data that includes information about the applications that are subject to a license.

Different actions might be taken in response to a determination that an application is subject to a license. For example, licensing information might be stored that includes data that identifies the applications that executed during a specified time, the amount of time the applications executed (e.g., determined from multiple snapshot backups and/or an assembled snapshot backup), a number of computing devices on which the applications executed, and the like. In some examples, the licensing information may be used to help enforce the terms of the license.

In some examples, simulated PUF responses might be emulated for VMs. Traditional PUFs may refer to computations performed on a processor such that the outcome is logically difficult to predict but which are repeatable. For example, a PUF generated by one particular computing device should be different from another PUF generated by a different computing device since the value of the PUF may depend on physical irregularities, set randomly when the computing device was being constructed. PUFs can be used to verify a computing device or as a source of identity assertion.

Since VMs may not always execute on the same computing device, a simulated PUF generator may be configured to provide consistent and distinct simulated PUF responses between different VMs executing on the same computing device while keeping consistent simulated PUF responses in the same VM even when the VM is executing on a different computing device. In some examples, a PUF call detector may detect when a PUF call is made by a VM. A simulated PUF generator may generate a simulated PUF response for the VM. The simulated PUF may be used for licensing or some other purpose. More details relating to using snapshot backups and the use of simulated PUFs are provided below.

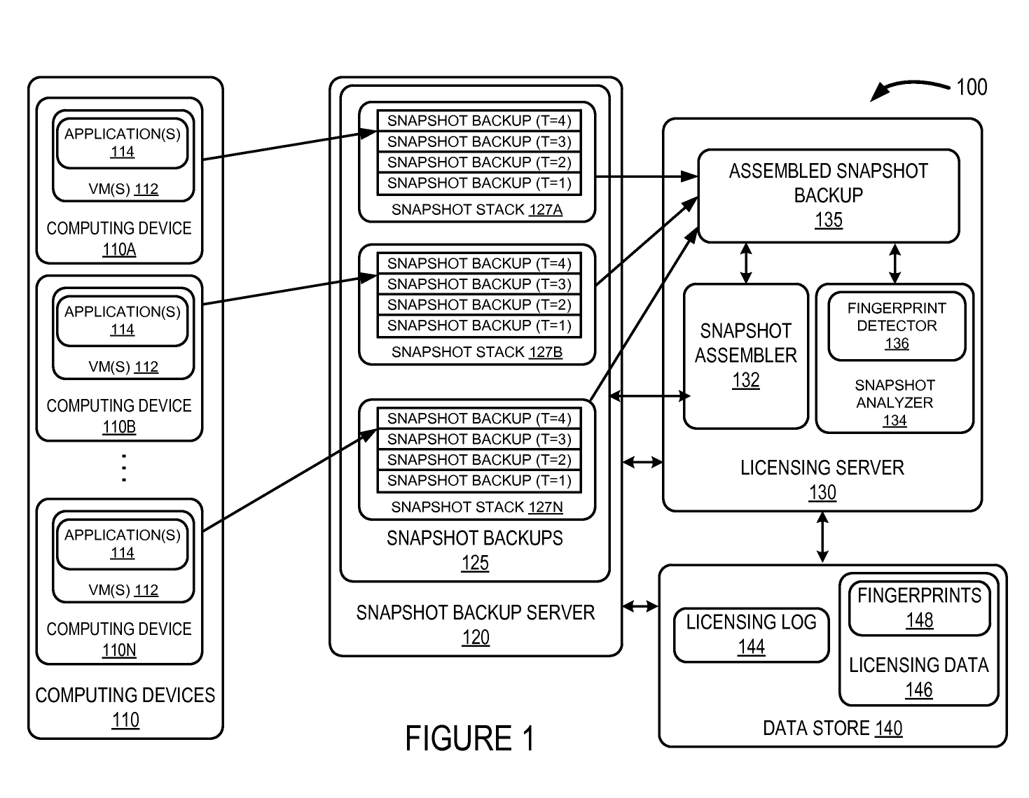

FIG. 1 is a functional block diagram illustrating an example licensing system 100 configured to utilize snapshot backups, arranged in accordance with at least some embodiments presented herein. As illustrated, the licensing system 100 includes computing devices 110, a snapshot backup server 120, a licensing server 130, and a data store 140. One or more of the computing devices 110 may be coupled to the snapshot backup server 120. The snapshot backup server 120 may be coupled to the licensing server 130 and/or the data store 140. The licensing server 130 may also be coupled to the data store 140.

The computing devices 110 might be any type of computing device operative to execute applications and/or VMs. For example, the computing devices 110 might be servers operative to execute one or more virtual machines (VMs) 112 within a data center or some other operating environment. A virtual machine (VM) may refer to a software implementation of a computing device. For example, a VM may be configured to execute software like a physical machine. The same computing device, such as the computing device 110A, may execute the same type of VMs or different types of VMs. For example, one of the VM(s) 112 on the computing device 110A may run a first operating system whereas another one of the VM(s) 112 on the computing device 110A might run a second operating system. In some examples, the computing devices 110 may be part of a data center. For example, the computing devices 110A-110N may be configured to provide remote storage, processing, or some other type of service. In some examples the computing devices 110 might execute one or more operating systems and applications directly without virtualization.

The VM(s) 112 may be configured to execute one or more application(s) 114. For example, the computing device 110A might execute one VM that runs a single application and execute another VM that runs multiple applications. Each of the computing devices 110 may execute a different number of VM(s) 112 as well as execute a different number of application(s) 114. The application(s) 114 that are associated with one or more of the VM(s) 112 might be subject to a software license. In some examples, one or more of the application(s) 114 may execute outside of a VM.

The data store 140 may be configured to store licensing data 146 regarding the application(s) 114. In some examples, the licensing data 146 includes information about the application(s) 114 that are subject to a software license. For example, the licensing data 146 might include data identifying the application(s) 114 that are subject to a license and/or license terms. In some examples, the licensing data 146 may include one or more fingerprints 148 that may be used to identify the applications. As discussed in more detail below, a fingerprint may uniquely identify an application.

The snapshot backup server 120 may be configured to perform or obtain snapshot backups 125 that are associated with one or more of the computing devices 110. In the current example, the snapshot backup server 120 obtains snapshot backups 125 associated with each of the computing devices (e.g., the computing devices 110A-110N). In some examples, the snapshot backup server 120 may store a snapshot stack (e.g., snapshot stacks 127A-127N), that is associated with each of the computing devices 110. A snapshot stack may refer to snapshot backups 125 that are associated with one or more of the computing devices 110. For example, the snapshot stack 127A may include one or more snapshot backups 125 taken at different points in time (e.g., from T=1 to T=4) for the computing device 110A. In some configurations, each snapshot backup 125 at a given time may be incremental in nature. Similarly, the snapshot stack 127B may include one or more snapshot backups 125 taken at different points in time (e.g., from T=1 to T=4) for the computing device 110B. A snapshot stack might exist for each computing device that is backed up using snapshot backups 125.

The snapshot backups 125 may be stored on the snapshot backup server 120, stored on some other data store (e.g., the data store 140), or stored in some memory. In some examples, the computing devices 110 may already be backed up using snapshot backups 125. Stated another way, the snapshot backups 125 that are already being used for backing up the computing devices 110 may also be used for licensing and determining the application(s) 114 that are subject to a license.

In contrast to traditional backups that utilize scanning and copying, which may consume a large amount of computing resources, a snapshot backup may be obtained without placing as much additional load on the computing devices 110 executing the VM(s) 112 and the application(s) 114. In some examples, snapshot deduplication might also be employed that may reduce snapshot backup size by up to 99%. Specialized hardware (not shown) might also be used to obtain the snapshot backups 135.

A snapshot assembler 132 illustrated in the licensing server 130 may be configured to assemble snapshot backups 125 to generate an assembled snapshot backup 135. The assembled snapshot backup 135 may include snapshot backups 125 from one or more of the snapshot stacks, such as from the snapshot stacks 127A-127N. In some examples, the snapshot assembler 132 may assemble a different assembled snapshot backup 135 for each of the different snapshot stacks. For example, a first assembled snapshot backup 135 may be assembled from the snapshot backups 125 obtained from the computing device 110A. A second assembled snapshot backup 135 may be assembled from the snapshot backups 125 obtained from the computing device 110B, or the like. In other examples, the snapshot assembler 132 may assemble the assembled snapshot backup 135 that combines snapshot backups 125 from different snapshot stacks. In still other examples, the snapshot assembler 132 may generate the assembled snapshot backup using a previously generated assembled snapshot backup 135 in conjunction with other snapshot backups.

In some examples, the snapshot assembler 132 is configured to assemble snapshot backups 125 into the assembled snapshot backup 135 in accordance with a schedule and/or some other timing mechanism (e.g., periodically, in response to an occurrence of an event, or some other condition). For example, the assembled snapshot backup 135 might be assembled and/or updated every few minutes (e.g., two to five minutes).

Once generated, the assembled snapshot backup 135 may be examined by the snapshot analyzer 134, or some other computing device, to identify the application(s) 114 that were executing on the one or more computing devices 110 during the times the snapshots were taken on the computing device, or the computing devices 110, that are associated with the assembled snapshot backup 135. For example, the snapshot analyzer 134 might analyze a first assembled snapshot backup 135 that is associated with the computing device 110A, a second assembled snapshot backup 135 that is associated with the computing device 110B, and the like. In other configurations, the snapshot analyzer 134 might analyze a combined assembled snapshot backup 135 that includes snapshot backups from each of the computing devices 110A-110N.

In some examples, the determination by the snapshot analyzer 134 of whether an application is subject to a license may be performed on separate processes and computing devices from the computing device (e.g., one or more of the computing devices 110) that are executing the application(s) 114 or an instance of the application(s) 114 (e.g., VM 112A-112N). As discussed above, in some examples, the snapshot backups 125 may already be collected by the snapshot backup server 120. As such, there may be no to minimal impact on the performance of the computing devices 110 when determining whether the application(s) 114 are subject to a license.

The snapshot analyzer 134 may determine whether the application(s) 114 are subject to a license in near real time or the determination might be deferred until a later time. For example, since the licensing determinations might be performed using the assembled snapshot backup 135, the current state of the memory of the computing devices 110 does not need to be constantly checked. As long as one or more of the snapshot backups 125 are maintained or the assembled snapshot backup 135 is maintained, the snapshot analyzer 134 might perform the determination of what application(s) 114 were executing at the time the related snapshot backup was taken.

Identification of the application(s) 114 utilizing the snapshot backups 125 might be performed by the snapshot analyzer 134 using any one or more of a number of different mechanisms. For example, a fingerprinting mechanism, such as a fingerprint detector 136 might be used to determine the application(s) 114 that are executing on a computing device at a time a snapshot backup is taken. A “fingerprint” in digital terms may refer to a compact representation of a state or object. For example, fingerprinting may help to enable recognition of particular software, such as the application(s) 114 in memory of the computing devices 110 executing the VM(s) 112.

All or a portion of the application(s) 114 might be fingerprinted by generating a number of memory page hashes or signatures. These hashes may be statistically unique (very low chance of duplication) to the data in the memory being analyzed. For detecting the application(s) 114 in use at the time the snapshot backup is taken, one mechanism may be to produce a fingerprint for execution code blocks of memory (e.g., blocks that will not change with program state) and multiple fingerprints may be used for each of the application(s) 114 to be detected in order to help ensure that the application(s) 114 are in memory and not just part of a stale swap cache.

In some examples, a software vendor, or some other user or computer-process might generate and provide fingerprints for the execution memory contents for each binary software version they make. Fingerprints may typically be small, so storing large numbers of fingerprints does not typically pose a storage problem. In some examples, the fingerprints may be stored in the licensing data 146 or the data store 140. The fingerprints 148 might also be associated with other information regarding the application(s) 114 such as the software vendor that provided the application(s) 114, licensing terms for the application(s) 114, or application programming interface (“API”) addresses for the licensing server 130 to access or report licensing information.

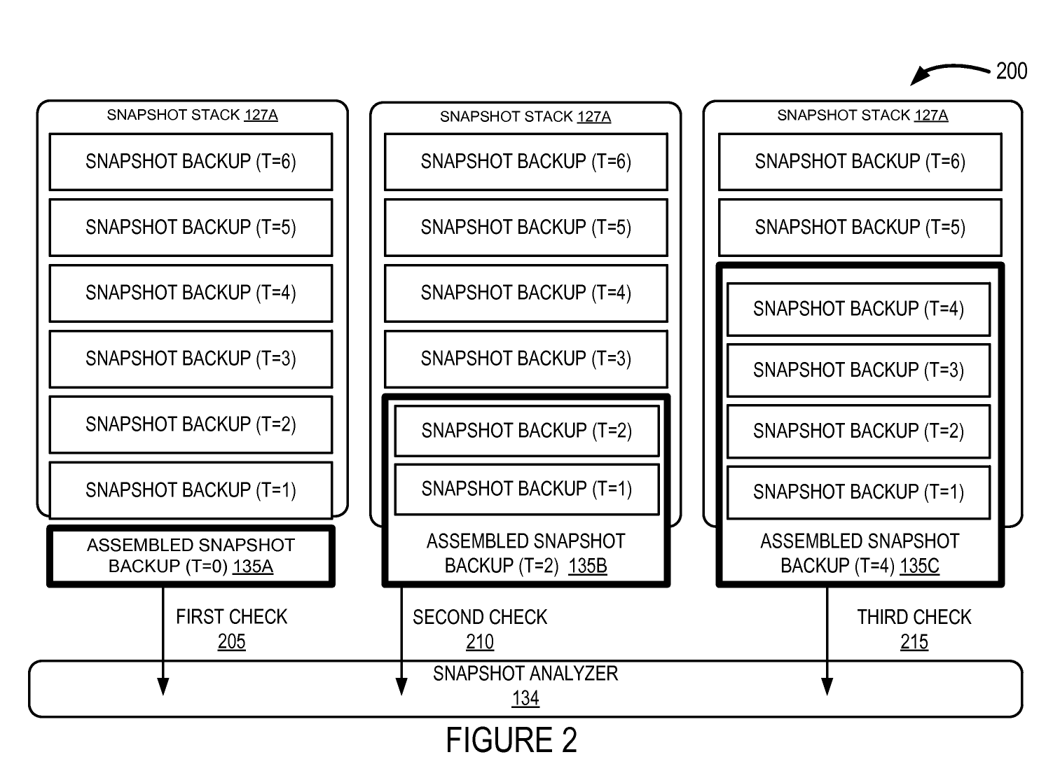

As discussed, the licensing server 130, utilizing the snapshot analyzer 134, may be configured to analyze the assembled snapshot backup 135 to determine the application(s) 114 that might be executing at the time of one or more of the snapshot backups 125 that form the assembled snapshot backup 135. For example, a search for WINDOWS binaries on each WINDOWS VM might be performed by the snapshot analyzer 134 by checking a hash of a portion of the assembled snapshot backup 135 with a hash of a portion of the WINDOWS binaries at different times to determine whether the hashes are the same. Hashes of the same value may indicate that the WINDOWS binaries were executing or resident at a time the snapshot backups were taken. The checking may be further streamlined by assembling the relevant hashes for a given architecture into Bloom filters and checking hashes from different assembled snapshot backups (e.g., assembled snapshot backups 135A-135C as illustrated in FIG. 2) against the Bloom filter, which may be small enough to reside in memory.

Other fingerprinting mechanisms may include the placement of particular “tags” such as globally unique identifications (“GUIDs”) in eXtensible markup language (“XML”) labels within the memory image of their applications. Software companies may register software fingerprints that may be stored in the licensing data 146 or provide examples to be fingerprinted and the licensing server 130 may return counts of the application and amounts of time the detected application(s) 114 are in use or may offer billing directly

Another form of fingerprinting that might be used may involve flow extraction. Flow extraction may refer to a form of fingerprint that reflects the structure and operation of the application(s) 114. Flow extraction may be beneficial for analyzing variable optimization for just in time compiled code. Flow extraction may determine functional flow trees from compiled byte code, scripts, or raw code and may be used for dynamic adaptation of code. The output of flow extraction may be some form of numbering of execution units in a graph/tree format with connections between elements representing execution flow. This analysis might be performed using a hypervisor (not shown) that may be associated with a computing device, such as one or more of the computing devices 110A-110N.

In some configurations, more than one fingerprint may be matched by the fingerprint detector 136. This might assist in preventing false alarms for flow diagrams (which are not necessarily as unique as deduplication style hashes). For example, the fingerprint detector 136 may receive five flow extraction fingerprints for each application 114 to detect and consider a match of 4 out of 5 flow extraction fingerprints to be a detection event (e.g., it is confirmed that an application that is subject to a license is located in the assembled snapshot backup 135).

The licensing server 130 may be configured to store licensing information in a licensing log 145 as illustrated in the data store 140. For example, the licensing server 130 might store data identifying the applications (e.g., licensed and/or unlicensed) that have executed during a specified time, an amount of time the applications have executed, a number of computing devices on which the applications have executed, and the like. In some examples, the licensing information stored in the licensing log 144, or some other memory or data store, may be used to help enforce the terms of one or more licenses.

FIG. 2 is a functional block diagram illustrating a snapshot analyzer 134 configured to analyze assembled snapshot backups for application(s) 114 executing on one or more computing devices 110 at different points in time, arranged in accordance with at least some embodiments presented herein. While the snapshot analyzer 134 is shown separately from the licensing server 130, the snapshot analyzer 134 may be included within the licensing server 130, within the snapshot backup server 120, or within some other computing device.

As illustrated, the snapshot analyzer 134 may analyze the assembled snapshot backup 135 at different points in time. A first check 205 of an assembled snapshot backup 135A may be performed by the snapshot analyzer 134 at a first point in time. An assembled snapshot backup 135, such as the assembled snapshot backup 135A might include a specified number of snapshot backups 125 (e.g., two, three, four). In some examples, the number of snapshot backups 125 that are included in the assembled snapshot backup 135 may change over time. As illustrated, an assembled snapshot backup 135B may have two more snapshot backups 125 as compared to the assembled snapshot backup 135A and an assembled snapshot backup 135C may have four more snapshot backups 125 as compared to the assembled snapshot backup 135A. In other examples, the assembled snapshot backup 135 might have a same number of snapshot backups 125 at different times.

The snapshot backups 125 that are assembled and analyzed may be current snapshot backups 125 or older in time snapshot backups 125. In other words, any snapshot backup might be used when determining whether an application is subject to a license. As such, in some embodiments, the determination of the application(s) that are subject to a license might be delayed or rescheduled (e.g., moved to a later time) without affecting accuracy of the determination of whether one or more of the application(s) 114 is subject to a license. As such, the licensing server 130 may be flexible and scaled to free up resources at busy moments and then determining the application(s) 114 that are subject to a license when resource demand decreases.

The assembled snapshot backups, such as the assembled snapshot backups 135A-135C, may be evaluated for application(s) 114 that are subject to a license. In some examples, to reduce the size of the assembled snapshot backups, the operating system and known software that is not subject to licensing may be ignored (e.g., via hash tables as in deduplication). In other examples, if the assembled snapshot backup 135, such as the assembled snapshot backup 135A, does not include any application(s) 114 that are subject to a license, the next check for licensed applications may only check the snapshot backups 125 obtained since the last check for the licensed applications. For example, the second check 210 might only check the snapshot backup at T=1 and the snapshot backup at T=2 to identify any application(s) 114 that may be subject to a license.

In some examples, in an attempt to avoid issues with applications partially loaded at the edge of a snapshot backup, the range of the snapshot backups 125 may be overlapped. For example, the assembled snapshot backup 135C might include snapshot backups that are also included in another assembled snapshot backup 135, such as the assembled snapshot backup 135B.

While the examination of the snapshot backups 125 and the assembled snapshot backup 135 is described with respect to licensing, the information determined by the snapshot analyzer 134 might be used for other purposes. For example, the snapshot analyzer 134 might determine metrics about the applications and/or resources used and determined from the snapshot backups 125. In some instances, a software provider, or some other authorized user, might register applications to track. The metrics obtained using the snapshot backups 125 might be used to provide business intelligence tools. For example, companies might use the tools to discover how much their employees are using various applications.

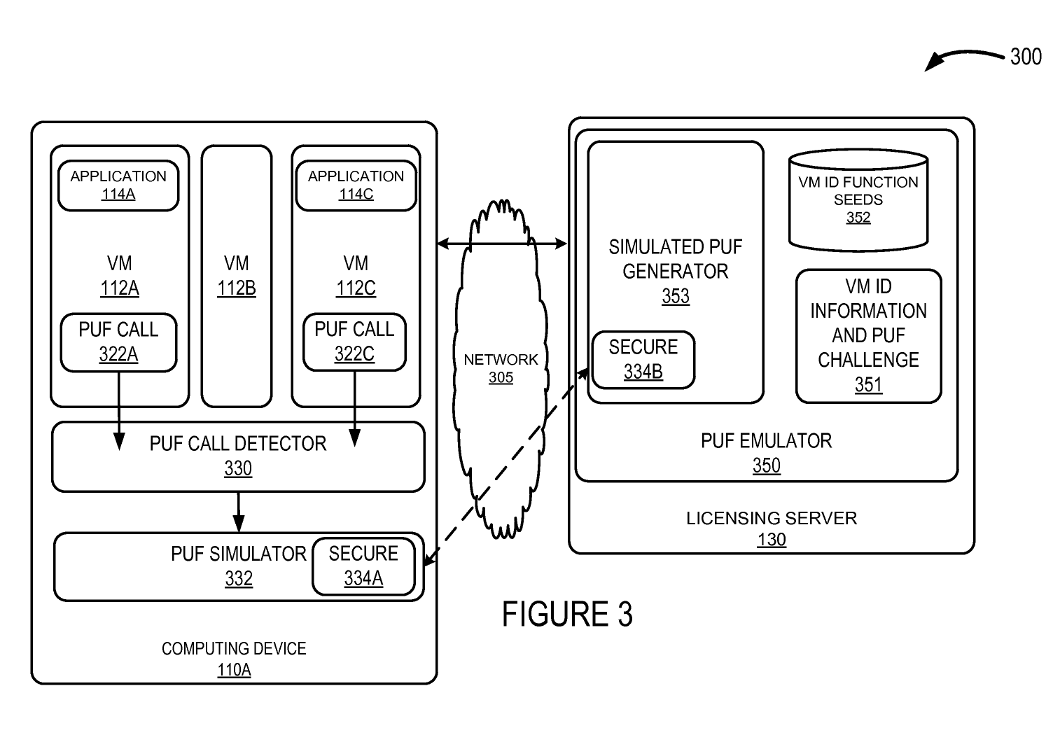

FIG. 3 is a functional block diagram illustrating a PUF system 300 configured to generate and deliver simulated PUFs, in accordance with at least some embodiments described herein. As illustrated, the system 300 includes the computing device 110A coupled through a network 305 to the licensing server 130, or some other computing device. The computing device 110A may include one or more VMs, such as the VM 112A-112C, as well as a PUF call detector 330 and a PUF simulator 332. The licensing server 130 may include a PUF emulator 350 that may include a simulated PUF generator 353, a VM ID function seeds data store 352, and VM ID information and PUF challenge 351.

In some examples, PUFs may be used in determining whether an application, such as the application 114A, is being executed in accordance with licensing requirements. The PUFs may be used to establish which computing device, such as the computing device 110A, is executing a licensed application (e.g., VM 112A). For example, a particular license that is associated with a PUF might be used to lock the application 114A to a particular machine. In some examples, the licensing server 130 may test a PUF against a particular state of the application (e.g., in response to being launched or some other state).

As discussed herein, traditional PUFs may refer to computations performed on a processor such that the outcome is logically uncertain, for example dependent on instability or timing, but which are repeatable on a particular processor because the outcome is dependent on tiny physical irregularities set randomly during fabrication such as the exact capacitance between physical wires or the process variation between two transistors.

Traditional PUFs may be used to verify a device or as a source of identity assertion. A traditional PUF is characterized by a PUF challenge that results in a response that is determined by random hardware variations. In some examples, different cryptography mechanisms, such as Feige-Fiat-Shamir identification mechanism, may be used to prove PUF possession without revealing information that could weaken later request sessions. Generally, the Feige-Fiat-Shamir identification mechanism may allow a first party to prove to a second party that the first party possesses secret information without having to reveal the secret information to the second party.

The PUF emulator 350 may be configured to track the identity of virtual machines, such as the VM 112A and the VM 112C, in order to provide consistent and distinct simulated PUF responses between different VMs on the same computing device, while keeping consistent simulated PUF responses in the same VM even when the VM is executed on a different computing device. A “simulated” PUF response may refer to a response that mimics a traditional PUF response. According to some examples, a simulated PUF response will be consistent for a same VM even when it changes hardware. Similarly, simulated PUF responses for different VMs on the same servers or different servers will be different.

The PUF call detector 330 illustrated in the computing device 110A may be configured to detect PUF calls made from a VM. For example, the PUF call detector 330 may detect the PUF call 322A from the VM 112A and detect the PUF call 322C made by the VM 112C. The simulated PUF generator 353 may be configured to generate simulated PUF responses based on both a challenge and an identifier that is associated with a VM. In response to the PUF call detector 330 receiving a PUF call, such as the PUF call 322A or the PUF call 322C, the PUF simulator 332 may request a simulated PUF response from the simulate PUF generator 353.

The PUF emulator 350 may be configured to simulate PUFs external to the VM that are delivered consistently to that VM even as it migrates among servers. The use of simulated PUFs may allow a datacenter to utilize PUF based licensing by limiting a particular virtual PUF (e.g., generated by the simulated PUF generator 353) to a single VM such that even multiple instances based off the same VM image receive distinct and persistent PUFs. In the current example, the PUF response generated by the simulated PUF generator 353 is not related to the actual hardware of the computing device 110A. Instead, each of the different VMs (e.g., VM 112A-112C) executing on the computing device 110A each may receive different PUFs from the PUF emulator 350.

The PUF simulator 332 may communicate VM ID information and the PUF challenge 351 to the PUF emulator 350. The VM ID information and PUF challenge 351 may be provided to the simulated PUF generator 353 that may retrieve function seeds or other VM-specific PUF generative information from a data storage 352, or some other memory or data store, by accessing the information specific to the VM ID associated with the request.

The simulated PUF generator 353 may use the VM-specific seed retrieved from the data storage 352 to generate a simulated PUF response to the challenge. For example, the PUF response may be generated using an AES hash, or some other secure hash, iterated some target number of times, or using some other statistical mechanism. An AES-hash, or some other hash, may take an arbitrary bit string as input and return a fixed length string as output.

In some examples, the PUF simulator 332 uses secure communications 334A and 334B across the network 305 to reach the PUF emulator 350 on the licensing server 130. For example, the PUF response may be delivered through secure communications 334A-334B back to the PUF simulator 332 that provides the virtualized PUF response to the VMs. The PUF call 322A and the PUF call 322C, despite being on the same computing device 110A, receive unique and distinct simulated PUF responses for identical challenge data since they are in different VMs (e.g., VM 112A and VM 112C). The VM ID information may be used to select among distinct response seeds. The VMs (e.g., VM 112 and VM 112C) may also receive consistent PUF responses as the VMs migrate from one computing device to another computing device.

The PUF call detector 330 may detect and trap attempts to generate a PUF. In some cases, applications that access PUFs install low-level bit access drivers or link libraries. These drivers or libraries may be programmatically or manually detected and paravirtualized for use in a virtualized environment. Since PUF generation might be characterized by purposely generating output that is sensitive to chip-to-chip variation, the PUF calls are generally quite unlike anything else that would be purposefully done by a computing device. In some examples, a PUF may be generated by declaring specific physical memory addresses and then reading them immediately without filling them. Since this memory operation has no valid purpose other than generating a PUF, it can be safely trapped by a virtualization layer. Other examples of generating a PUF for a VM might include feeding two nominally identical clocks into counters and then conducting a check to see which counter is higher. In some examples, direct communication between the simulated PUF generator 353 and the outside world may be prevented (e.g., using rules or other networking features).

The simulated PUF generator 353 may be restricted to servicing the computing devices 110 that are part of a same network and/or datacenter. Encrypted network connections might also be used for additional security. In some examples, the simulated PUF generator 353 might use hardware generated PUFs to secure communications with the computing device 110A. The simulated PUF generator 353 may use a secure communication mechanism (e.g., the secure 334A and 33B) to communicate the PUF response to the PUF simulator 332.

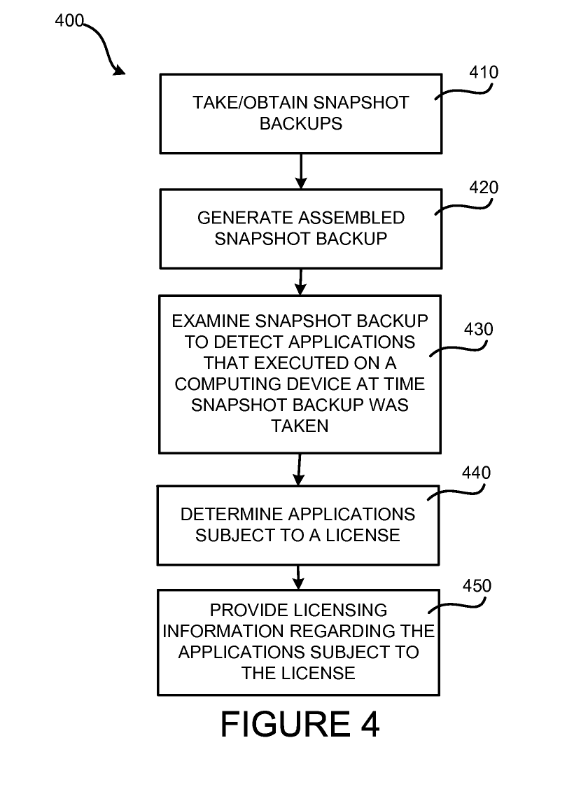

FIG. 4 is a flow diagram illustrating an example process 400 adapted to use snapshot backups for licensing, in accordance with at least some embodiments presented herein. The process 400 may begin at operation 410 (“TAKE/OBTAIN SNAPSHOT BACKUPS”), where one or more snapshot backups 125 may be taken or obtained. As discussed above, the snapshot backup server 120, or some other computing device, may be configured to take one or more snapshot backups 125 and to store them in a memory or some other data store. For example, the snapshot backups 125 may be stored on the licensing server 130 or the data store 140.

From operation 410, the process 400 may move to operation 420 (“GENERATE ASSEMBLED SNAPSHOT BACKUP”) where an assembled snapshot backup 135 may be generated. As discussed above, the snapshot assembler 132 may generate the assembled snapshot backup 135 using two or more of the snapshot backups 125 that are associated with one or more of the computing devices 110. In some examples, the snapshot assembler 132 may generate an assembled snapshot backup 135 at specified times, in response to an event, or in response to some other trigger.

From operation 420, the process 400 may move to operation 430 (“EXAMINE SNAPSHOT BACKUP TO DETECT APPLICATIONS THAT EXECUTED ON A COMPUTING DEVICE AT TIME SNAPSHOT BACKUP WAS TAKEN”) where a snapshot backup, such as the assembled snapshot backup 135, may be examined to detect the applications that executed on a computing device at a time the snapshot backup was taken. As discussed above, the snapshot analyzer 134 may be configured to analyze the assembled snapshot backup 135 using a fingerprint mechanism, such as the fingerprint detector 136. Generally, the assembled snapshot backup 135 may be analyzed to identify the application(s) 114 that are subject to a license.

From operation 430, the process 400 may move to operation 440 (“DETERMINE APPLICATIONS SUBJECT TO A LICENSE”) where a determination may be made as to what applications are subject to a license. As discussed above, the licensing server 130 may access the licensing data 146 in the data store 140 to determine the application(s) 114 that are subject to a license.

From operation 440, the process 400 may move to operation 450 (“PROVIDE LICENSING INFORMATION REGARDING THE APPLICATIONS SUBJECT TO THE LICENSE”) where licensing information may be provided regarding the applications that are subject to the license. As discussed above, the licensing information might be provided by the licensing server 130 and may include information such as how long the licensed applications have been executed within a time, how many instances of the licensed applications have executed, or the like. The process 400 might then proceed to an end operation (not shown).

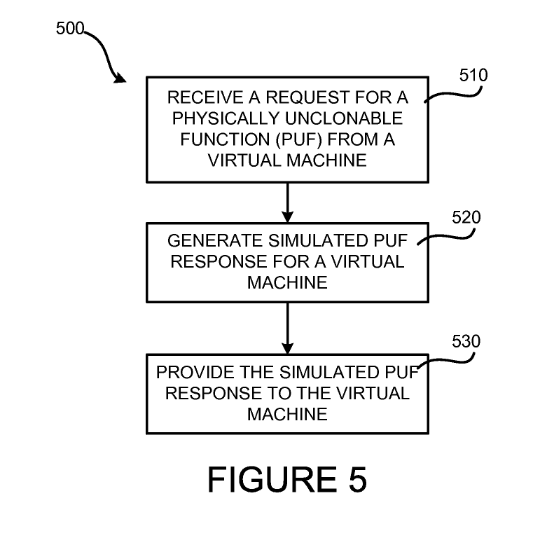

FIG. 5 is a flow diagram illustrating an example process 500 adapted to use PUFs with virtual machines, in accordance with at least some embodiments presented herein. The process 500 may begin at operation 510 (“RECEIVE A REQUEST FOR A PHYSICALLY UNCLONABLE FUNCTION (PUF) FROM A VIRTUAL MACHINE”), where a request may be received from a virtual machine for a PUF. As discussed above, the PUF call detector 330 may be configured to intercept a PUF call, such as the PUF call 322A, from an application. In some examples, the PUF call 322A may be received from a VM, such as the VM 112A.

From operation 510, the process 500 may move to operation 520 (“GENERATE SIMULATED PUF RESPONSE FOR A VIRTUAL MACHINE”) where a simulated PUF response may be generated for a virtual machine. In some examples, the simulated PUF response may be generated by the simulated PUF generator 353. As discussed above, the simulated PUF response may uniquely identify the VM executing the application regardless of the computing device executing the VM.

From operation 520, the process 500 may move to operation 530 (“PROVIDE THE SIMULATED PUF RESPONSE TO THE VIRTUAL MACHINE”) where the PUF response may be provided to the virtual machine. As discussed above, the simulated PUF generator 353 may use a secure communication mechanism, (e.g., the secure 334A and 33B) to communicate the simulated PUF response. In some examples, the PUF simulator 332 may communicate the simulated PUF response to the VM requesting the PUF. The process 500 might then proceed to an end operation (not shown).

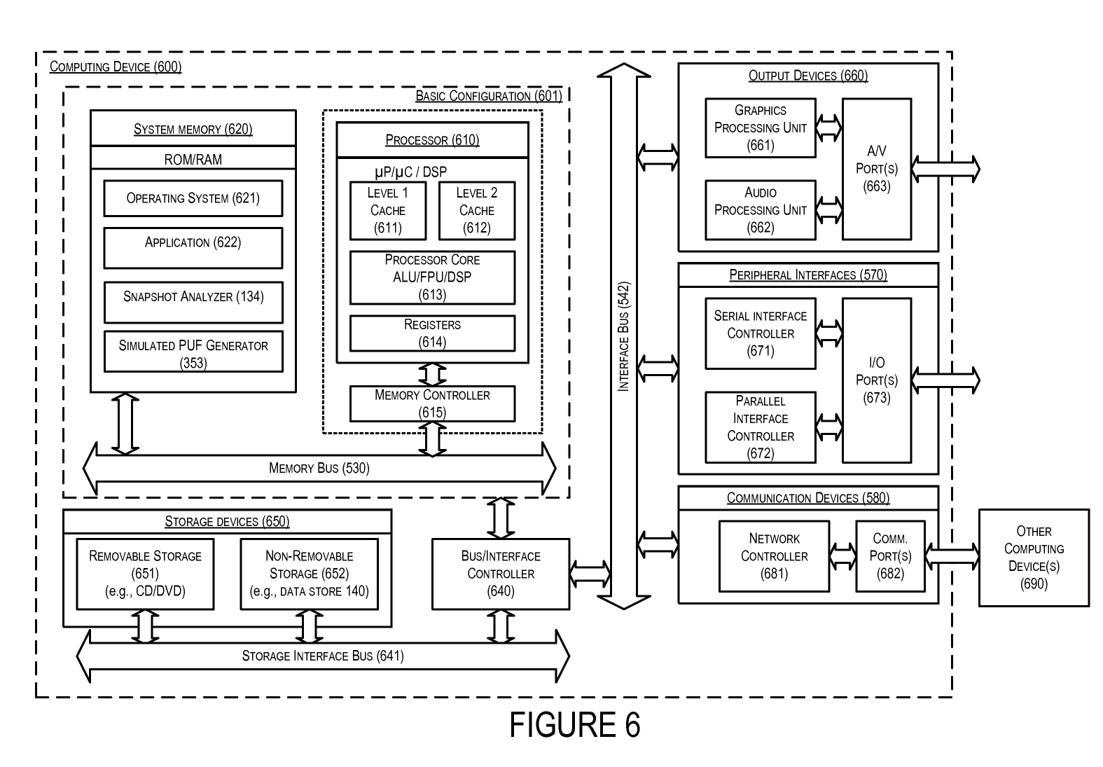

FIG. 6 is a block diagram illustrating an example computing device 600 that is arranged to implement technologies relating to licensing of software using snapshot backups 135, in accordance with at least some embodiments described herein. The computer 600 may be implemented as a conventional computer system, an embedded control computer, a laptop, a server computer, a mobile device, a set-top box, a kiosk, a vehicular information system, a mobile telephone, a customized machine, or other hardware platform. The processor 610 may be configured to implement the logic described above.

In a very basic configuration 601, computing device 600 typically includes one or more processors 610 and system memory 620. A memory bus 630 can be used for communicating between the processor 610 and the system memory 620.

Depending on the desired configuration, processor 610 can be of any type including, but not limited to, a microprocessor (“g”), a microcontroller (“μC”), a digital signal processor (“DSP”), or any combination thereof. Processor 610 can include one more levels of caching, such as a level one cache 611 and a level two cache 612, a processor core 613, and registers 614. The processor core 613 can include an arithmetic logic unit (“ALU”), a floating point unit (“FPU”), a digital signal processing core (“DSP Core”), or any combination thereof. A memory controller 615 can also be used with the processor 610, or in some implementations the memory controller 615 can be an internal part of the processor 610. The processor 610 can be a multi-core processor having two or more independent processing units (“cores”).

Depending on the desired configuration, the system memory 620 can be of any type including, but not limited to, volatile memory (such as RAM), nonvolatile memory (such as ROM, flash memory, etc.) or any combination thereof. System memory 620 typically includes an operating system 621 and one or more applications 622. The system memory 620 might also include the snapshot analyzer 134, the simulated PUF generator 353, as well as other components, as described above.

The computing device 600 may have additional features or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or a combination thereof. Examples of removable storage and non-removable storage devices include magnetic disk devices such as flexible disk drives and hard-disk drives (“HDD”s), optical disk drives such as compact disk (“CD”) drives or digital versatile disk (“DVD”) drives, solid state drives (“SSD”s), and tape drives to name a few. Example computer storage media can include volatile and nonvolatile, removable and non-removable media implemented in any method or technology for storage of information, such as computer readable instructions, data structures, program modules, or other data.

System memory 620, removable storage devices 651 and non-removable storage devices 652 are all examples of computer storage media. Computer storage media includes, but is not limited to, RAM, ROM, EEPROM, flash memory or other memory technology, CD-ROM, digital versatile disks (“DVD” s) or other optical storage, magnetic cassettes, magnetic tape, magnetic disk storage or other magnetic storage devices, or any other medium which can be used to store the desired information and which can be accessed by computing device 600. Any such computer storage media can be part of the computing device 600.

The computing device 600 can also include an interface bus 642 for facilitating communication from various interface devices (e.g., output interfaces, peripheral interfaces, and communication interfaces) to the basic configuration 601 via the bus/interface controller 640. Example output devices 660 include a graphics processing unit 661 and an audio processing unit 662, which can be configured to communicate to various external devices such as a display or speakers via one or more A/V ports 663. The example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which can be arranged to facilitate communications with one or more other computing devices 690 over a network communication via one or more communication ports 682. The communication connection is one example of a communication media.

Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, communication media can include wired media such as a wired network or direct-wired connection, and wireless media such as acoustic, radio frequency (“RF”), infrared (“IR”), Fiber Optics, and other wireless media. The term computer readable media as used herein can include both storage media and communication media.

Computing device 600 can be implemented as a portion of a small-form factor portable (or “mobile”) electronic device such as a cell phone, a personal data assistant (“PDA”), a personal media player device, a wireless web-watch device, a personal headset device, an application specific device, or a hybrid device that include any of the above functions. Computing device 600 can also be implemented as a personal computer including both laptop computer and non-laptop computer configurations.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multi-core processor systems, microprocessor-based or programmable consumer electronics, minicomputers, mainframe computers, and the like.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the Detailed Description, claims, or Figures, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 elements refers to groups having 1, 2, or 3 elements. Similarly, a group having 1-5 elements refers to groups having 1, 2, 3, 4, or 5 elements, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to manage software licenses, the method comprising:
accessing a snapshot backup, the snapshot backup taken during an execution of a virtual machine on a server;
examining the snapshot backup to detect applications that executed on the server at a time the snapshot backup was taken;
determining that one or more of the applications are subject to a license; and
providing licensing information that includes information associated with the one or more of the applications that are subject to the license.

2. The method of claim 1, further comprising assembling snapshot backups into an assembled snapshot backup, and wherein examining the snapshot backup comprises examining the assembled snapshot backup to detect applications that executed on one or more servers at a time the snapshot backups in the assembled snapshot backup were taken.

3. The method of claim 2, further comprising storing the assembled snapshot backup in a licensing server.

4. The method of claim 1, wherein examining the snapshot backup comprises using fingerprinting to recognize a particular application.

5. The method of claim 1, wherein examining the snapshot backup comprises using flow extraction to recognize a particular application.

6. The method of claim 1, further comprising generating the licensing information within a data center comprising servers configured to execute virtual machines, and storing the licensing information on one or more data stores in the data center.

7. The method of claim 1, wherein the snapshot backup comprises a copy of a memory of the server at a time the snapshot backup was taken.

8. The method of claim 1, wherein accessing the snapshot backup occurs prior to the snapshot backup being removed from a snapshot backup server.

9. An apparatus, comprising:
a network interface coupled to a server, the server being configured to execute virtual machines; and
a processor, coupled to the interface, the processor configured to
access snapshot backups that are taken during an execution of one or more virtual machines on the server,
examine the snapshot backups to detect applications that executed on the server that are subject to one or more licenses, and
store licensing information comprising information about the applications that are subject to the one or more licenses.

10. The apparatus of claim 9, wherein the processor is further configured to assemble two or more of the snapshot backups into an assembled snapshot.

11. The apparatus of claim 9, wherein the processor is further configured to provide the licensing information to a location that is outside of a data center that includes the server.

12. The apparatus of claim 9, wherein to examine the snapshot backups comprises to use a fingerprinting mechanism to recognize the applications.

13. The apparatus of claim 9, wherein to examine the snapshot backups comprises to use flow extraction to recognize the applications.

14. The apparatus of claim 9, wherein the processor is further configured to generate the licensing information.

15. The apparatus of claim 9, wherein each of the snapshot backups includes a server state that comprises a copy of a memory of the server at a time the snapshot backup was taken.

16. The apparatus of claim 9, wherein one or more of the virtual machines use a physically unclonable function (PUF) for verification.

17. A method to provide a simulated physically unclonable function (PUF) response, the method comprising:
receiving a request for a PUF response from a virtual machine (VM) on a first computing device;
generating the simulated PUF response for the VM, wherein a value of the simulated PUF response remains consistent for the VM regardless of a physical computing device executing the VM; and
providing the simulated PUF response to the VM.

18. The method of claim 17, wherein the generating the simulated PUF response occurs on a different computing device from the first computing device.

19. The method of claim 17, wherein generating the simulated PUF response for the VM comprises accessing a seed that is associated with the VM that is used in the PUF when generating the simulated PUF response for the VM.

20. The method of claim 17, wherein the simulated PUF response is used in licensing an application that is associated with the VM.
